(19) United States
(12) Patent Application Publication
(10) Pub. No.: US 2011/0203469 A1
(43) Pub. Date: Aug. 25, 2011

(54) CONVERSION OF PRINTING PLATE CYLINDERS FOR INCREASED PRINTING LENGTH

(76) Inventors: Robert M. Deis, Hudson, WI (US); Edward L. Frandrup, Vermillion, MN (US)

(21) Appl. No.: 12/862,142

(22) Filed: Aug. 24, 2010

Related U.S. Application Data
(60) Provisional application No. 61/236,325, filed on Aug. 24, 2009.

(51) Int. Cl. B41F 1/28

(52) U.S. Cl. 101/415.1

(57) ABSTRACT

Devices for converting a printing plate cylinder from a first configuration that provides a first printable length to a second configuration that provides a second printable length greater than the first printable length

### CROSS-REFERENCE TO RELATED APPLICATION

This application claims the benefit under 35 USC §119(e) of U.S. Provisional Patent Application No. 61/236,325, filed Aug. 24, 2009, which is incorporated herein by reference in its entirety and for all purposes.

### TECHNICAL FIELD

The present invention relates generally to printing presses. More particularly, the present invention relates to conversion of printing plate cylinders from a first configuration that provides a first printable length to a second configuration that provides a second printable length greater than the first printable length. In an exemplary embodiment, the present invention relates to conversion of printing plate cylinders from a two-page-around configuration to a three-page-around configuration.

### BACKGROUND

A schematic drawing of an exemplary printing unit 10 for use in web printing is shown in FIG. 1. The printing unit 10 includes, among other functional components, plate cylinders 12 and blanket cylinders 14. In use, the blanket cylinders 14 press web 16 (or substrate), typically paper, against printing plates, 18 and 20, mounted on the plate cylinders 12 that include the image to be printed. The printing plates, 18 and 20, as shown, are wrapped around the plate cylinders 12 and secured in place with two lockup mechanisms, 22 and 24, that are each removably positioned within respective channel, 26 and 28, of the plate cylinders 12.

The printing unit 10 illustrated in FIG. 1 is conventionally referred to as being configured for two-page-around printing because two printing plates are used to form two printed pages. In one configuration, both printing plates have the same image so that two identical pages are printed with one revolution of the plate cylinders 12. In another configuration, the printing plates have different images such as consecutive pages so that two pages can be printed with one revolution of the plate cylinders 12.

Referring to FIG. 2, an exemplary web 16 to be printed is shown. In the illustrated exemplary two-page-around configuration there are two printable image regions, 15 and 17, of the web 16 having length x (and width that depends on the particular printing unit) and two non-printable regions, 19 and 21, of the web 16 where no image is printed having length y. Printable image regions, 15 and 17, correspond with image regions of printing plates, 18 and 20, respectively. Non-printable regions, 19 and 21, include a margin adjacent the ends of printing plates, 18 and 20, and the space (or gap) between the ends of printing plates, 18 and 20, that exists when printing plates, 18 and 20, are held in place with lockup mechanisms, 22 and 24. In this configuration, the maximum length of a printed page is limited to x.

In some printing applications it is desirable to maximize the length of printable area. One exemplary application is where it is desired to use a single printing plate to form three pages. Other exemplary applications include where it is desired to print a single page of increased length or plural pages of desired length. Printing plate cylinders configured for forming three pages are conventionally referred to as having a three-page-around configuration. The most common way to convert a printing plate cylinder configured for two-page-around printing to a plate cylinder configured for three-page-around printing is to replace the printing cylinders. Replacement of printing cylinders can be costly and time consuming. Moreover, replacement of printing cylinders requires significant time to convert back to the two-page-around configuration if desired.

### SUMMARY

The present invention thus provides devices that can be inserted in place of a lockup mechanism (or similar device) in a printing plate cylinder to convert the printing plate cylinder from a first configuration that provides a first printable length to a second configuration that provides a second printable length greater than the first printable length.

In an exemplary aspect of the present invention a conversion device for use with a printing plate cylinder to replace a lockup mechanism (or similar device) is provided. The conversion device preferably comprises one or more mounting features to attach the device to a printing plate cylinder and a support surface having a radius substantially matching the radius of a supporting surface of the printing plate cylinder.

In another exemplary aspect of the present invention a method of converting a printing plate cylinder from a first configuration that provides a first printable length to a second configuration that provides a second printable length greater than the first printable length is provided. The method comprises removing a lockup mechanism (or similar device) from a channel of a printing plate cylinder and positioning a conversion device in accordance with the present invention in the channel of the printing plate cylinder, wherein the conversion device comprises a supporting surface having a radius matching the radius of the supporting surface of the printing plate cylinder.

In another exemplary aspect of the present invention a method of converting a printing plate cylinder from a two-page-around configuration to a three-page-around configuration is provided. The method comprises removing a lockup mechanism (or similar device) from a channel of a printing plate cylinder and positioning a conversion device in accordance with the present invention in the channel of the printing plate cylinder, wherein the conversion device comprises a supporting surface having a radius matching the radius of the supporting surface of the printing plate cylinder.

### BRIEF DESCRIPTION OF THE DRAWINGS

The accompanying drawings, which are incorporated in and constitute a part of this disclosure, illustrate several aspects of the present invention and together with description of the exemplary embodiments serve to explain the principles of the present invention. A brief description of the drawings is as follows:

FIG. 1 is a schematic view of an exemplary printing unit showing plate cylinders having printing plates and that can include a conversion device in accordance with the present invention in the place of a lockup mechanism (or similar device).

FIG. 2 is a schematic view of an exemplary web that can be printed on with the printing unit shown in FIG. 1 and showing exemplary printable and non-printable areas for an exemplary two-page-around configuration.

FIG. 3A is a partial perspective view of an exemplary plate cylinder having an exemplary conversion device in accordance with the present invention in the place of a lockup mechanism (or similar device).

FIG. 3B is an end view of the plate cylinder of FIG. 3A.

FIG. 3C is a partial cross-sectional of the plate cylinder of FIG. 3A.

FIG. 3D is a partial top view of the plate cylinder of FIG. 3A.

FIG. 4 is a schematic view of an exemplary web that can be printed on with the printing unit shown in FIG. 1 and showing exemplary printable and non-printable areas for an exemplary single plate configuration in accordance with the present invention.

FIG. 5A is a partial cross-sectional view of the conversion device of the plate cylinder of FIGS. 3A-3D.

FIG. 5B is a partial cross-sectional view of the conversion device of the plate cylinder of FIGS. 3A-3D and showing in particular an exemplary fastener used to fasten the conversion device to the plate cylinder in accordance with the present invention.

FIG. 5C is a partial cross-sectional view of a portion of the conversion device of the plate cylinder of FIGS. 3A-3D.

FIG. 6A is a perspective view of another exemplary conversion device in accordance with the present invention.

FIG. 6B is a top view of the conversion device shown in FIG. 6A.

FIG. 6C is a side view of the conversion device shown in FIG. 6A.

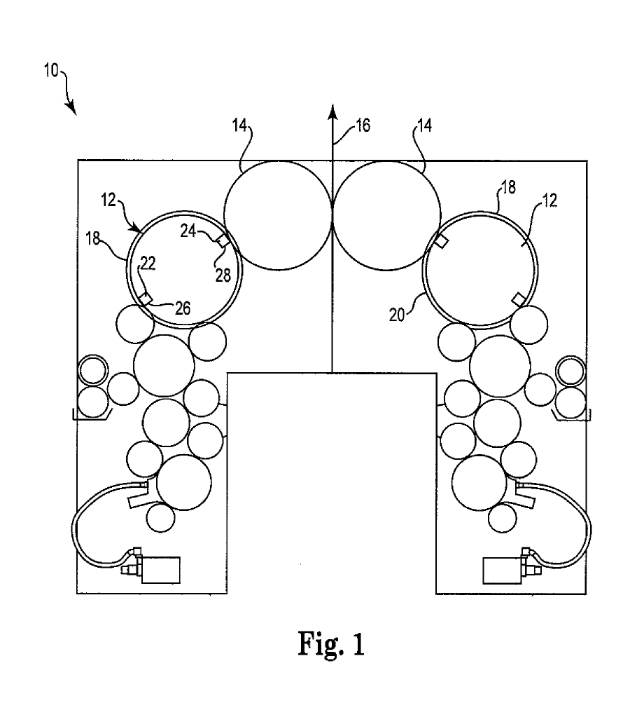

### DETAILED DESCRIPTION

The exemplary embodiments of the present invention described herein are not intended to be exhaustive or to limit the present invention to the precise forms disclosed in the following detailed description. Rather the exemplary embodiments described herein are chosen and described so those skilled in the art can appreciate and understand the principles and practices of the present invention.

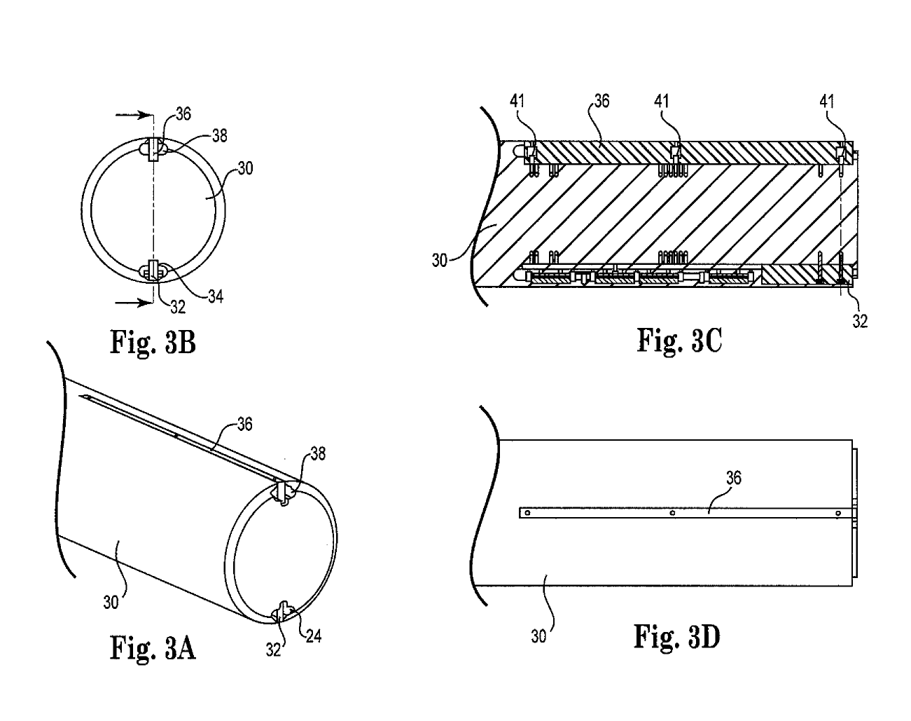

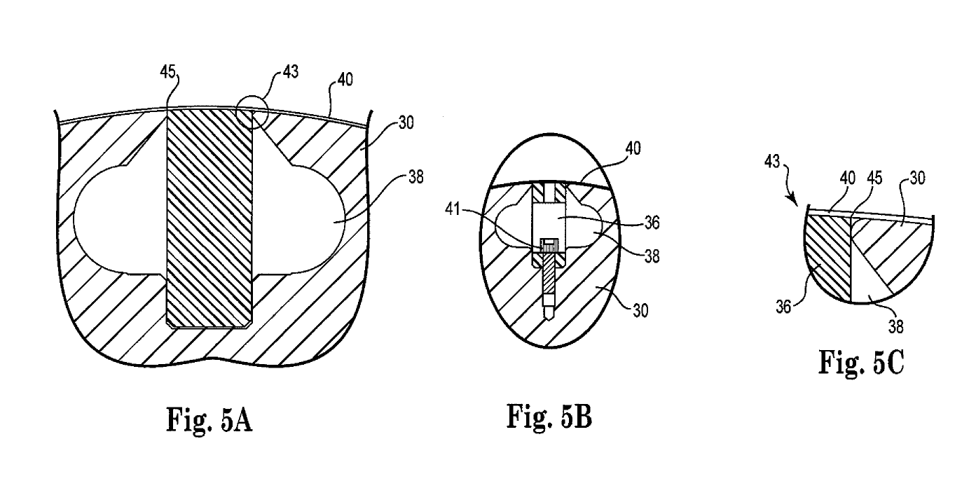

An exemplary plate cylinder 30 modified in accordance with the present invention is illustrated in FIGS. 3A-3D. Plate cylinder 30 is modified in accordance with the present invention to convert plate cylinder 30 from a first configuration using two printing plates (plates not shown) to a second printing configuration using a single printing plate (plate not shown). As shown, plate cylinder 30 includes lockup mechanism 32 positioned in channel 34 and conversion device 36 positioned in channel 38 (replacing the second lockup mechanism). Conversion device 36 is preferably secured in channel 38 with exemplary fasteners 41, as shown in described below with respect to FIG. 5B.

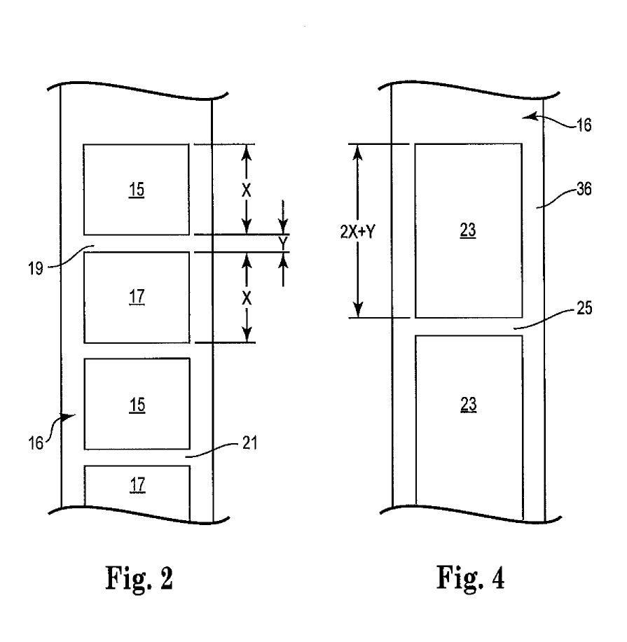

Referring to FIG. 4, exemplary web 16 shows printable area 23 and non-printable area 25 for an exemplary single plate configuration in accordance with the present invention. In this exemplary configuration the length of printable area 23 is equal to 2x+y as compared to the web shown in FIG. 2. Advantageously, using conversion devices in accordance with the present invention thus provides an increased printable length by providing the ability to print an image in non-image area 19.

Referring to FIGS. 5A-5C, cross-sectional views of conversion device 36 as positioned within channel 34 of plate cylinder 30 are shown. In FIGS. 5A-5C, printing plate 40 is shown as operatively positioned on and supported by plate cylinder 30. Referring to FIG. 5B, a partial cross-sectional view of conversion device 36 taken through exemplary fastener 41 is shown. Fastener 41, as shown, comprises a conventional threaded bolt. It is contemplated however, that any desired fastening technique can be used to functionally and operatively secure a conversion device relative to a plate cylinder in accordance with the present invention. Moreover, fasteners that provide additional functionality, such as for adjusting the position of a conversion device relative to a plate cylinder in accordance with the present invention can be used. Devices for providing such adjusting can also comprise a device distinct from a device, such as a fastener or the like, for securing a conversion device relative to a plate cylinder in accordance with the present invention.

In typical use, pressure is applied to printing plate 40 to transfer an image from printing plate 40 to a substrate or web such as paper, for example. To provide image transfer, printing plate 40 needs to be properly and sufficiently supported to receive such pressure. ASuch support is provided by the outside surface of plate cylinder 30 and is important for achieving the desired image quality. However, when a plate cylinder having plural lockup mechanisms (or similar devices), such as exemplary plate cylinder 30, is used with a single printing plate (such as printing plate 40), only one of the lockup mechanisms is needed. Omission of the additional lockup mechanism(s) creates an undesired gap in the supporting surface of the plate cylinder corresponding with the channel of the additional lockup mechanism(s). See for example, channel 38 of plate cylinder 30. This gap causes the region of printing plate corresponding with the gap to be unsupported, which can cause poor or no image transfer at that region.

Exemplary conversion device 36 in accordance with the present invention can be used to replace a lockup mechanism (or similar device) and provide adequate support of printing plate 40 to prevent undesired loss of image transfer. Using a conversion device in accordane with the present invention, a plate cylinder configured for use with two (or more) printing plates can easily be converted to a plate cylinder configured for use with a single printing plate. Advantageously, the entire plate cylinder does not need to be replaced.

A conversion device in accordance with the present invention is preferably designed to mount in place of a lockup mechanism (or similar device) of a printing cylinder. Preferably, mounting features of the plate cylinder such as threaded holes and the like are used to mount the conversion device to the printing cylinder to avoid the need to modify the printing cylinder. Any mounting for securing techniques for positioning a conversion device in accordance with the present invention relative to a plate cylinder can be used.

A conversion device in accordance with the present invention preferably provides a supporting surface for a printing plate in place of a gap created by omission of a lockup mechanism (or similar device). Preferably, the supporting surface of the conversion device has the same radius as that of the outside supporting surface of the printing cylinder.

Omission of a lockup mechanism of a plate cylinder can potentially create an imbalance when the printing cylinders rotated at printing speeds. A conversion device in accordance with the present invention is preferably designed to provide proper balance of the plate cylinder with which the conversion device is used. In particular, the conversion device can be designed to incorporate geometry that provides proper balancing at desired rotational speeds. Such balancing can also be provided by addition of one or more balancing weights or by removal of material such as by drilling or cutting and opening.

A conversion device in accordance with the present invention can be made as a single part or can be made of a plurality of assembled parts.

A conversion device in accordance with the present invention preferably includes one or more features that allow the position of the conversion device to be adjusted relative to a plate cylinder in which the conversion device is installed. In one exemplary embodiment, conventional shims are used. In another exemplary embodiment, mechanical devices integrated with a conversion device are used. For example, one or more set screws can be used to adjust the position of the conversion device relative to a plate cylinder. Preferably, the supporting surface of the conversion device is sufficiently aligned with the supporting surface of a plate cylinder so a sufficiently smooth transition between the supporting surface of the plate cylinder and the supporting surface of the conversion device is provided. See FIG. 5C, for example, which shows the portion of FIG. 5A identified with reference numeral 43. Preferably, as shown, conversion device 36 includes bench 45 that minimizes any potential gap (or un-supporting region) between conversion device 36 and plate cylinder 30. Conversion device 36, in the region where conversion device 36 meets plate cylinder 30, may comprise any features or geometry such as extension portions or the like that function to minimize any potential gap formed between conversion device 36 and plate cylinder 30.

Any desired material can be used for a conversion device in accordance with the present invention. Preferably, the material used for a conversion device matches the material used for a plate cylinder of which the conversion device is used. The materials of the conversion devices and plate cylinders do not, however, need to match. Dissimilar materials can be used, if desired.

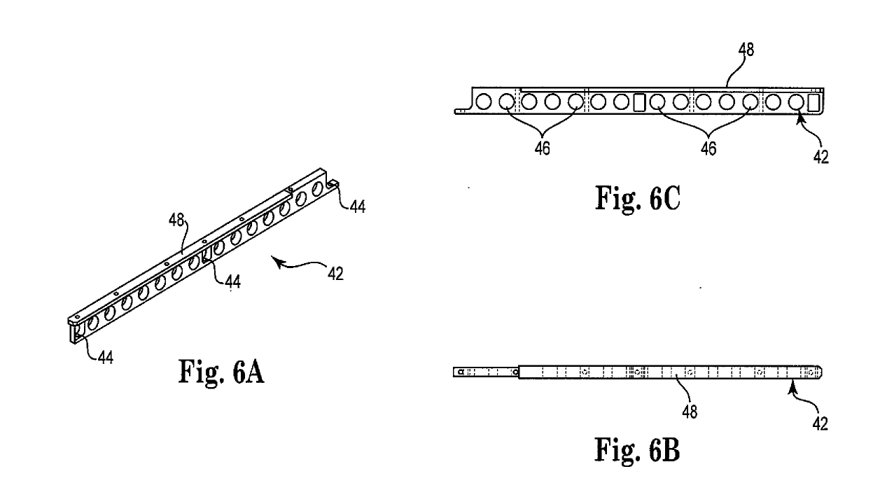

An exemplary conversion device 42 in accordance with the present invention is shown in FIG. 6 and can be used in the same manner as described with respect to conversion device 36 herein. Conversion device 42 comprises mounting features 44 for attaching conversion device 44 to a plate cylinder and includes openings 46 for mass management of conversion device 42. Conversion device 42 also includes support surface 48 and which is formed to have the radius of the plate with which conversion device 42 will be used. Other geometrical aspects of conversion device 42 are determined based on the particular plate cylinder with which conversion device 42 will be used.

The present invention has now been described with reference to several exemplary embodiments thereof. The entire disclosure of any patent or patent application identified herein is hereby incorporated by reference for all purposes. The foregoing disclosure has been provided for clarity of understanding by those skilled in the art of printing technology. No unnecessary limitations should be taken from the foregoing disclosure. It will be apparent to those skilled in the art that changes can be made in the exemplary embodiments described herein without departing from the scope of the present invention. Thus, the scope of the present invention should not be limited to the exemplary structures and methods described herein, but only by the structures and methods described by the language of the claims and the equivalents of those claimed structures and methods.

What is claimed is:

1. A conversion device for use with a printing plate cylinder to replace a lockup mechanism, the conversion device comprising a body comprising one or more mounting features to attach the device to a printing plate cylinder and a support surface having a radius substantially matching the radius of a printing plate support surface of the printing plate cylinder.

2. The conversion device of claim 1, comprising one or more adjusting device that can adjust the position of the support surface of the conversion device relative to the printing plate support surface of the printing plate cylinder.

3. The conversion device of claim 1, comprising one or more balancing feature.

4. The conversion device of claim 3, wherein the one or more balancing feature comprises at least one of addition or removal of weight.

5. The conversion device of claim 1 in combination with a printing plate cylinder.

6. The combination of claim 5, wherein the conversion device is positioned in a channel of the printing plate cylinder.

7. A method of converting a printing plate cylinder from a first configuration that provides a first printable length to a second configuration that provides a second printable length greater than the first printable length, the method comprising:
removing a lockup mechanism from a channel of a printing plate cylinder; and
positioning a conversion device in the channel of the printing plate cylinder, wherein the conversion device comprises a support surface having a radius matching the radius of the support surface of the printing plate cylinder.

8. The method of claim 7, comprising aligning the support surface of the conversion device with the support surface of the printing plate cylinder.

9. The method of claim 8, comprising aligning the support surface of the conversion device with the support surface of the printing plate cylinder by adjusting the position of the support surface of the conversion device relative to the support surface of the printing plate cylinder.

10. The method of claim 7, comprising mounting a printing plate on the printing plate cylinder.

11. A method of converting a printing plate cylinder from a two-page-around configuration to a three-page-around configuration, the method comprising:
removing a lockup mechanism from a channel of a printing plate cylinder; and
positioning a conversion device in the channel of the printing plate cylinder, wherein the conversion device comprises a support surface having a radius matching the radius of the support surface of the printing plate cylinder.

12. The method of claim 11, comprising aligning the support surface of the conversion device with the support surface of the printing plate cylinder.

13. The method of claim 12, comprising aligning the support surface of the conversion device with the support surface of the printing plate cylinder by adjusting the position of the support surface of the conversion device relative to the support surface of the printing plate cylinder.

14. The method of claim 11, comprising mounting a printing plate on the printing plate cylinder.
